(19) United States
(12) Patent Application Publication
(10) Pub. No.: US 2026/0205951 A1
(43) Pub. Date: Jul. 16, 2026

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Youjun HU, Shenzhen (CN); Mengzhu CHEN, Shenzhen (CN); Bo DAI, Shenzhen (CN); Weiwei YANG, Shenzhen (CN); Kun LIU, Shenzhen (CN); Xiaoying MA, Shenzhen (CN); Jun XU, Shenzhen (CN); Qiujin GUO, Shenzhen (CN)

(73) Assignee: ZTE CORPORATION, Shenzhen (CN)

(21) Appl. No.: 19/559,635

(22) Filed: Mar. 6, 2026

Related U.S. Application Data
(63) Continuation of application No. PCT/CN2023/135204, filed on Nov. 29, 2023.

(51) Int. Cl. H04W 52/02

(52) U.S. Cl. CPC H04W 52/0235

(57) ABSTRACT

A wireless communication method is disclosed. The method comprises monitoring, by a wireless communication terminal, a physical downlink control channel, PDCCH, during an active time based on at least a low power wake up signal, LP-WUS.

### CROSS-REFERENCE TO RELATED PATENT APPLICATIONS

This application is a Continuation of International Application PCT/CN2023/135204, filed Nov. 29, 2023, incorporated herein by reference in its entirety.

### TECHNICAL FIELD

This document is directed generally to wireless communications, including but not limited to 5th generation (5G) communications or 6th generation (6G) communications.

### BACKGROUND

Low-Power Wake-Up Signal (LP-WUS) can be used to reduce power consumption of User Equipment (UE), which is received by Wake-Up Receiver (WUR), and to trigger the MR (Main Radio) monitoring Physical Downlink Control Channel (PDCCH). However, the LP-WUS related configurations, such as relationship between the LP-WUS and DRX (Discontinuous Reception) or Extended Discontinuous Reception (eDRX), triggering the MR for monitoring PDCCH, or retransmission configurations, are still topic of discussion.

### SUMMARY

This document relates to methods, systems, and computer program products for a wireless communication.

This document relates to methods, systems, and computer program products for a wireless communication.

One aspect of the present disclosure relates to a wireless communication method. In an embodiment, the wireless communication method includes: monitoring, by a wireless communication terminal, a physical downlink control channel, PDCCH, during an active time based on at least a low power wake up signal, LP-WUS.

Another aspect of the present disclosure relates to a wireless communication method. In an embodiment, the wireless communication method includes: transmitting, by a wireless communication node to a wireless communication terminal, a low power wake up signal, LP-WUS, to indicate wireless communication terminal to monitor the physical downlink control channel, PDCCH, during an active time.

Another aspect of the present disclosure relates to a wireless communication terminal. In an embodiment, the wireless communication terminal includes a communication unit and a processor. The processor is configured to: monitor, via the communication unit, a physical downlink control channel, PDCCH, during an active time based on at least a low power wake up signal, LP-WUS.

Another aspect of the present disclosure relates to a wireless communication node. In an embodiment, the wireless communication node includes a communication unit and a processor. The processor is configured to: transmit, via the communication unit to a wireless communication terminal, a low power wake up signal, LP-WUS, to indicate wireless communication terminal to monitor the physical downlink control channel, PDCCH, during an active time.

Various embodiments may implement the following features:

Preferably or in some embodiments, the active time is determined by an LP-WUS timer or a Discontinuous Reception, DRX, timer,
wherein an LP-WUS active time is determined by the LP-WUS timer
wherein a DRX active time is determined by the DRX timer.

Preferably or in some embodiments, the DRX timer comprises at least one of:
a DRX on-Duration Timer;
a DRX Inactivity Timer;
a DRX Retransmission Timer for downlink, DL;
a DRX Retransmission Timer for uplink, UL;
a DRX Hybrid Automatic Repeat Request, HARQ, round trip time, RTT, Timer for DL; or
a DRX HARQ RTT Timer for UL.

Preferably or in some embodiments, the LP-WUS timer comprises at least one of:
an LP-WUS on-Duration Timer,
an LP-WUS Inactivity Timer,
an LP-WUS Retransmission Timer for downlink, DL, or
an LP-WUS Retransmission Timer for uplink, UL;
an LP-WUS HARQ RTT Timer for DL; or
an LP-WUS HARQ RTT Timer for UL.

Preferably or in some embodiments, the LP-WUS timer or DRX timer is triggered by the LP-WUS, or by the LP-WUS in response to a high layer configuration.

Preferably or in some embodiments, the active time comprises at least one of:
a time of an LP-WUS on-Duration Timer being running;
a time of an LP-WUS Inactivity Timer being running;
a time of an LP-WUS Retransmission Timer for DL being running;
a time of an LP-WUS Retransmission Timer for UL being running;
a time of an LP-WUS HARQ RTT Timer for DL being running;
a time of an LP-WUS HARQ RTT Timer for UL being running;
a time of a DRX on-Duration Timer being running;
a time of a DRX Inactivity Timer being running;
a time of a DRX Retransmission Timer for DL being running;
a time of a DRX Retransmission Timer for UL being running;
a time of a ra-ContentionResolutionTimer being running;
a time of msgB-ResponseWindow;
a time of a Scheduling Request sent on a physical uplink control channel, PUCCH, being pending;
a time that a PDCCH indicating a new transmission addressed to a Cell Radio Network Temporary Identifier, C-RNTI, of a Medium Access Control, MAC, entity not being received after successful reception of a Random Access Response for a Random Access Preamble not selected by the MAC entity among a contention-based Random Access Preamble; or
a time or time duration within a PTW.

Preferably or in some embodiments, the LP-WUS is monitored based at least one of:
a periodicity,
a time duration, or
an offset.

Preferably or in some embodiments, the periodicity for determining the LP-WUS monitoring is equal to a DRX periodicity or is associated with a DRX periodicity, or is determined based on a DRX periodicity.

Preferably or in some embodiments, the offset for determining the LP-WUS monitoring indicates at least one of:
a time gap between the LP-WUS and a start of a DRX timer;
a time gap between the LP-WUS and a start of an LP-WUS timer;
a time gap between the LP-WUS and a start of a DRX timer for long DRX cycle;
a time gap between the LP-WUS and a start of a DRX timer for short DRX cycle;
a time gap between the LP-WUS and a DRX duration or cycle;
a time gap between the LP-WUS and next DRX duration or cycle;
a time gap between the LP-WUS and a long DRX duration or cycle;
a time gap between the LP-WUS and a short DRX duration or cycle; or
a time gap between the LP-WUS and a PTW.

Preferably or in some embodiments, the DRX duration is determined by a DRX active time or DRX timer.

Preferably or in some embodiments, the LP-WUS comprises an indication for one or more DRX activations or one or more DRX timers.

Preferably or in some embodiments, the LP-WUS satisfies at least one of:
the LP-WUS indicates to activate or start a DRX, DRX configuration, or DRX timer;
the LP-WUS indicates to activate or start a DRX, DRX configuration, or DRX timer for a long DRX cycle;
the LP-WUS indicates to activate or start a DRX, DRX configuration, or DRX timer for a short DRX cycle;
a first LP-WUS indicates to activate or start a long DRX and a second LP-WUS activates a short DRX; or
the LP-WUS indicates to activate or start at least one of a long DRX or a short DRX based on at least one of a PDCCH or physical downlink shared channel, PDSCH.

Preferably or in some embodiments, a high layer parameter is configured, a Medium Access Control Control Element, MAC CE, signaling or a Downlink Control Information, DCI, signaling is received.

Preferably or in some embodiments, the LP-WUS comprises an indication for an offset.

Preferably or in some embodiments, the offset indicates at least one of:
a time gap between the LP-WUS and a DRX cycle, a start of a DRX timer, or a start of an LP-WUS timer;
a time gap between the LP-WUS and a PTW;
a time gap between the LP-WUS and a window;
a first offset based on a long DRX and a second offset based on a short DRX;
a first offset based on a start of a DRX timer or LP-WUS timer for a long DRX and a second offset based on a start of a DRX timer or LP-WUS timer for a short DRX;
a first offset based on a PTW window, an Extended Discontinuous Reception, eDRX, cycle or a window and a second offset based on a DRX cycle, a start of a DRX timer, or a start of an LP-WUS timer.

Preferably or in some embodiments, an LP-WUS occasion for monitoring the LP-WUS is located before a DRX cycle, or is associated with a DRX cycle.

Preferably or in some embodiments, the LP-WUS is monitored based on at least one of a first periodicity and a second periodicity.

Preferably or in some embodiments, the at least one of the first periodicity and the second periodicity satisfies at least one of:
the second periodicity is applied for a Page Time Window, PTW, containing at least one DRX cycle;
the first periodicity is applied for an Extended Discontinuous Reception, eDRX, cycle;
the second periodicity is applied for a short DRX cycle;
the first periodicity is applied for a long DRX cycle;
the first periodicity is applied for a window;
the second periodicity is applied within a window;
the first periodicity is applied for a first LP-WUS and the second periodicity is applied for a second LP-WUS;
the first periodicity is applied for a first monitoring search space of the LP-WUS and the second periodicity is applied for a second monitoring search space of the LP-WUS;
or
the first periodicity and second periodicity have a relationship of multiple times.

Preferably or in some embodiments, the LP-WUS is monitored in a window, and the window satisfies at least one of:
a length of the window is equal to a length of a PTW;
the window contains a PTW or contains at least a DRX cycle in a PTW;
the window contains at least one time duration;
the window is located before a start of a DRX timer or outside a DRX active time;
a periodicity is associated with the window;
a periodicity of the window is associated or equal to a periodicity of an Extended Discontinuous Reception, eDRX, cycle; or
there is an offset between the window and a PTW, a DRX cycle, an eDRX cycle, a start of a DRX timer, a start of an LP-WUS timer, or a time point.

Preferably or in some embodiments, the LP-WUS satisfies at least one of: the LP-WUS is monitored outside the active time;
the LP-WUS is monitored outside a DRX active time;
the LP-WUS is monitored before a start of a DRX timer or an LP-WUS timer;
the LP-WUS is monitored in a PTW; or
the LP-WUS is monitored outside the active time or before the active time but in a PTW.

Preferably or in some embodiments, the LP-WUS further satisfies at least one of:
the LP-WUS is monitored in at least a time duration; or
the LP-WUS is monitored with a periodicity.

Preferably or in some embodiments, the wireless communication method further comprises at least one of:
the wireless communication terminal reporting recent channel status information, CSI, based on a most recent CSI measurement occasion occurring in the active time;
the wireless communication terminal performing measurement of channel status information reference signal, CSI-RS, in the active time;
the wireless communication terminal being not required to perform measurement of channel status information reference signal, CSI-RS, outside active time;
the wireless communication terminal expecting that CSI-RS resources are available in the active time;
the wireless communication terminal not expecting that CSI-RS resources are available outside active time;
the wireless communication terminal reporting a CSI report in response to receiving at least one of a CSI-RS transmission occasion for channel measurement and CSI-RS or a channel status information interference measurement, CSI-IM, occasion for interference measurement in an active time no later than a CSI reference resource;
the wireless communication terminal dropping a CSI report if not receiving at least one of a CSI-RS transmission occasion for channel measurement and CSI-RS or a CSI-IM occasion for interference measurement in an LP-WUS active time no later than a CSI reference resource;
the wireless communication terminal reporting a CSI report in response to receiving at least one CSI-RS transmission occasion for each CSI-RS resource in a Resource Pair within the active time no later than CSI reference resource;
the wireless communication terminal dropping a CSI report in response to not receiving at least one CSI-RS transmission occasion for each CSI-RS resource in a Resource Pair within the active time no later than CSI reference resource;
the wireless communication terminal not expecting to receive a configuration of monitoring a DCI format 2_6 and the LP-WUS at the same time; or
the wireless communication terminal being not required to monitor the LP-WUS during the active time.

Preferably or in some embodiments, an LP-WUS function or parameter is configured or enabled, or the LP-WUS is received.

Preferably or in some embodiments, the wireless communication node configures a time duration set, and the active time is selected from the time duration set.

Preferably or in some embodiments, the wireless communication node configures a time duration set, and the LP-WUS indicates a time duration in the time duration set as the active time.

Preferably or in some embodiments, the LP-WUS is monitored based on a configuration of the wireless communication node.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompanying drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIGS. 1A, 1B, and 1C show schematic diagrams of PDCCH monitoring according to an embodiment of the present disclosure.

FIG. 2 shows a schematic diagram of monitoring method with DRX according to an embodiment of the present disclosure.

FIG. 3 shows a schematic diagram of monitoring method with DRX according to an embodiment of the present disclosure.

FIG. 4 shows a schematic diagram of monitoring method with DRX according to an embodiment of the present disclosure.

FIG. 5 shows a schematic diagram of monitoring method with DRX according to an embodiment of the present disclosure.

FIG. 6 shows a schematic diagram of monitoring method with eDRX according to an embodiment of the present disclosure.

FIG. 7 shows an example of a schematic diagram of a wireless communication terminal according to an embodiment of the present disclosure.

FIG. 8 shows an example of a schematic diagram of a wireless communication node according to an embodiment of the present disclosure.

FIGS. 9 and 10 show flowcharts of wireless communication methods according to some embodiments of the present disclosure.

### DETAILED DESCRIPTION

In the paragraphs below, some aspects of the present disclosure are provided, but the present disclosure is not limited thereto. Besides, different aspects described below can be combined unless expressly stated otherwise.

In some embodiments, some parameters/configurations may be indicated as below.

In some embodiments, drx-onDurationTimer could be the duration at the beginning of a DRX cycle. Or it could be the amount of time at the beginning of each DRX Cycle (DRX ON) to decode PDCCH during every DRX cycle before entering the power saving mode (DRX OFF).

In some embodiments, drx-InactivityTimer could be the duration after the PDCCH occasion in which a PDCCH indicates a new UL or DL transmission for the MAC entity. Or it could be the time period for which the UE should be active after successfully decoding a PDCCH indicating a new transmission (uplink (UL) or downlink (DL)). This timer is (re-) started upon receiving PDCCH for a new transmission (UL or DL). The value of this timer is configured in milliseconds (subframe level).

In some embodiments, drx-RetransmissionTimerUL and drx-HARQ-RTT-TimerUL could be used in uplink data retransmission handling. In some embodiments, drx-RetransmissionTimerDL and drx-HARQ-RTT-TimerDL could be used in downlink data re-transmission handling.

In some embodiments, drx-RetransmissionTimerDL could be the maximum duration until a DL retransmission is received.

In some embodiments, drx-RetransmissionTimerUL could be the maximum duration until a grant for UL retransmission is received.

In some embodiments, drx-HARQ-RTT-TimerDL could be the minimum duration before a DL assignment for HARQ retransmission is expected by the Medium Access Control (MAC) entity.

In some embodiments, drx-HARQ-RTT-TimerUL could be the minimum duration before a UL HARQ retransmission grant is expected by the MAC entity.

In some embodiments, ra-ContentionResolutionTimer could be the initial value for the contention resolution timer.

In some embodiments, msgB-ResponseWindow: the time window to monitor RA response(s).

In some embodiments, when DRX is configured, the Active time for Serving Cells in a DRX group includes the time while:
drx-onDurationTimer or drx-InactivityTimer configured for the DRX group is running; or
drx-RetaransmissionTimerDL or drx-RetransmissionTimerUL is running on any Serving Cell in the DRX group; or
ra-ContentionResolutionTimer or msgB-ResponseWindow is running; or
a Scheduling Request is sent on Physical Uplink Control Channel (PUCCH) and is pending; or
a PDCCH indicating a new transmission addressed to the Cell Radio Network Temporary Identifier (C-RNTI) of the MAC entity has not been received after successful reception of a Random Access Response for the Random Access Preamble not selected by the MAC entity among the contention-based Random Access Preamble.

In the paragraphs below, some aspects of the present disclosure are provided, but the present disclosure is not limited thereto. Besides, different aspects described below can be combined unless expressly stated otherwise.

### Aspect 1:

In some embodiments, configuration(s) for an MR monitoring after receiving an LP-WUS may include at least one of the following attributes:

### 1. Timer

In some embodiments, the timer(s) for the LP-WUS (e.g., for the MR monitoring the PDCCH) may be reused from the DRX configuration. For example, the parameters may include at least one of: drx-onDurationTimer, drx-InactivityTimer, drx-Retransmission TimerDL, drx-Retransmission TimerUL, drx-HARQ-RTT-TimerDL and/or drx-HARQ-RTT-TimerUL.

In some embodiments, the timer(s) for the LP-WUS on duration (e.g., Ipwus-onDurationTimer) may comprise at least one of {ms1, ms2, ms3, ms4, ms5, ms6, ms8, ms10, ms20, ms30, ms40, ms50, ms60, ms80, ms100, ms200, ms300, ms400, ms500, ms600, ms800, ms1000, ms1200, ms1600}. In some embodiments, the Ipwus-onDurationTimer could be the duration at the beginning of a DRX cycle triggered by the LP-WUS. In some embodiments, the Ipwus-onDurationTimer could be a window or duration triggered by the LP-WUS.

In some embodiments, the inactivity timer(s) for the LP-WUS (e.g., Ipwus-InactivityTimer) may comprise at least one of {ms0, ms1, ms2, ms3, ms4, ms5, ms6, ms8, ms10, ms20, ms30, ms40, ms50, ms60, ms80, ms100, ms200, ms300, ms500, ms750, ms1280, ms1920, ms2560}. In some embodiments, the Ipwus-InactivityTimer could be the duration after the PDCCH occasion in which a PDCCH indicates a new UL or DL transmission for the MAC entity. In some embodiments, the Ipwus-InactivityTimer could be the duration after the PDCCH occasion in which a PDCCH indicates a new UL or DL transmission in a slot for the MAC entity. In some embodiments, the Ipwus-InactivityTimer could be the duration after the PDCCH occasion in which a PDCCH indicates a new UL or DL transmission in a slot, e.g., last slot of a time window for the MAC entity.

In some embodiments, the downlink retransmission timer(s) for the LP-WUS (e.g., lpwus-RetransmissionTimerDL) may comprise at least one of {sl0, sl1, sl2, sl4, sl6, sl8, sl16, sl24, sl33, sl40, sl64, sl80, sl96, sl112, sl128, sl160, s1320}. In some embodiments, the Ipwus-RetransmissionTimerDL is the duration until a DL retransmission is received. In some embodiments, the Ipwus-RetransmissionTimerDL is the maximum duration until a DL retransmission is received. In some embodiments, the lpwus-RetransmissionTimerDL is the duration until a DL retransmission is received during a time window/duration triggered by the LP-WUS. In some embodiments, the Ipwus-RetransmissionTimerDL is the duration until a DL retransmission is received based on the LP-WUS.

In some embodiments, the uplink retransmission timer(s) for the LP-WUS (e.g., lpwus-RetransmissionTimerUL) may comprise at least of {sl0, sl1, sl2, sl4, sl6, sl8, sl16, sl24, sl33, sl40, sl64, sl80, sl96, sl112, sl128, s1160, s1320}. In some embodiments, the Ipwus-RetransmissionTimerUL is the duration until a grant for the UL retransmission is received. In some embodiments, the Ipwus-RetransmissionTimerUL is the maximum duration until a grant for the UL retransmission is received. In some embodiments, the Ipwus-RetransmissionTimerDL is the duration until a grant for the UL retransmission is received during a time window/duration triggered by an LP-WUS. In some embodiments, the Ipwus-RetransmissionTimerDL is the duration until a grant for the UL retransmission is received based on the LP-WUS.

In some embodiments, the LP-WUS timer or DRX timer is triggered by the LP-WUS, or by the LP-WUS in response to a high layer configuration. For example, when the LP-WUS is successfully received, or the LP-WUS indication is received/detected, the timer would be triggered or be triggered based on a time offset/gap/delay. For example, when a high larger parameter is configured, and the LP-WUS is successfully received or the LP-WUS indication is received/detected, the LP-WUS timer is triggered. When the high larger parameter is not configured or the parameter not indicating to trigger any LP-WUS timer, and the LP-WUS is successfully received or the LP-WUS indication is received/detected, the DRX timer is triggered. For example, when the LP-WUS is successfully received or the LP-WUS indication is received/detected, the DRX or LP-WUS timer would be triggered based on the higher configuration.

### 2. Window or Time Duration

In some embodiments, the window or time duration may be determined by the LP-WUS indication and/or gNodeB (gNB) configuration. In the time window or time duration, the UE may monitor PDCCH.

In some embodiments, the window or time duration comprise the active time duration, which comprises at least one of the values from timers for the LP-WUS, or the active time is depending on a timer, e.g., the active time for Serving Cells includes the time while:
lpwus-onDurationTimer or Ipwus-InactivityTimer is running; or
lpwus-RetransmissionTimerDL or Ipwus-RetransmissionTimerUL is running.

In some embodiments, the gNB configures the time duration set, comprising at least one of X time units. In some embodiments, X could be valued from timers for the LP-WUS.

In some embodiments, the gNB configures the time duration set, and the LP-WUS indicate one of the time durations. For example, Y bits to indicate one of the time durations from the set.

### 3. Offset

In some embodiments, the offset may indicate the time gap between the active time and LP-WUS, the time gap between the PDCCH occasion and LP-WUS, the time gap between DRX and the active time, the time gap between DRX and PDCCH occasion triggered by the LP-WUS, the time gap between the LP-WUS and a timer, e.g., the LP-WUS timer or DRX timer.

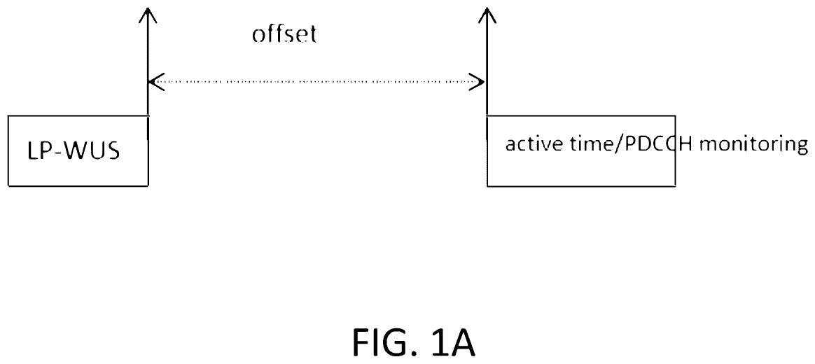

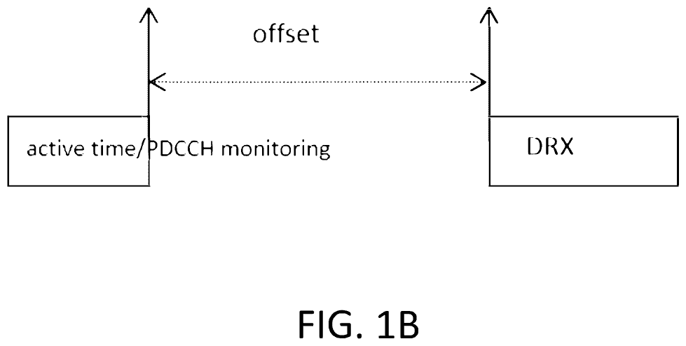

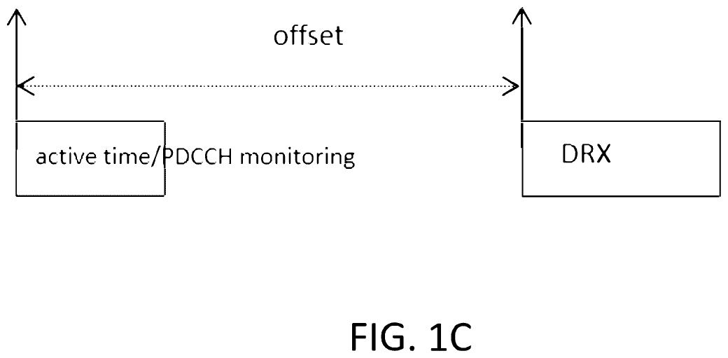

FIGS. 1A, 1B, and 1C illustrate schematic diagrams of offsets according to an embodiment of the present disclosure.

In some embodiments, the offset value could be an INTEGER, for example, from 0 to M, or from 1 to M, where M could be X−1.

In some embodiments, the LP-WUS indicates activating the next DRX and adjusts the active time or timer starting point with an offset.

In some embodiments, the LP-WUS indicates activating the next DRX with an offset after the LP-WUS.

In some embodiments, the LP-WUS indicates activating the next window or duration with an offset after the LP-WUS.

In some embodiments, the LP-WUS indicates the active time or PDCCH occasion with an offset after the LP-WUS.

### 4. DurationAndOffset

The parameter DurationAndOffset comprises the duration and the offset. For example, if the offset indicates the time gap based on DRX, this parameter could be defined. The duration means the DRX on-duration time.

In some embodiments, if duration is 10 ms, the LP-WUS could indicate one value from 0 to 9 and the duration is determined by DRX configuration (e.g., DRX-Config).

In some embodiments, the LP-WUS could indicate the time duration and the offset, the offset could be, for example, {½, ¼, ⅛, 1/16 . . . } of the duration.

### Active Time for Monitoring PDCCH

When the LP-WUS is configured (e.g., an LP-WUS function or parameter is configured), the active time for Serving Cells includes the time while:
lpwus-onDuration Timer or lpwus-InactivityTimer configured for the DRX group being running; or
lpwus-RetaransmissionTimerDL or lpwus-RetransmissionTimerUL being running on any Serving Cell in the DRX group; or
ra-ContentionResolutionTimer or msgB-ResponseWindow being running; or
a Scheduling Request is sent on PUCCH and being pending; or
a PDCCH indicating a new transmission addressed to the C-RNTI of the MAC entity has not been received after successful reception of a Random Access Response for the Random Access Preamble not selected by the MAC entity among the contention-based Random Access Preamble.
a time of an LP-WUS on-Duration Timer being running;
a time of an LP-WUS Inactivity Timer being running;
a time of an LP-WUS Retransmission Timer for DL being running;
a time of an LP-WUS Retransmission Timer for UL being running;
a time of an LP-WUS HARQ RTT Timer for DL being running;
a time of an LP-WUS HARQ RTT Timer for UL being running;
a time of a DRX on-Duration Timer being running;
a time of a DRX Inactivity Timer being running;
a time of a DRX Retransmission Timer for DL being running;
a time of a DRX Retransmission Timer for UL being running;
a time of a ra-ContentionResolutionTimer being running;
a time of msgB-ResponseWindow;
a time of a Scheduling Request sent on a physical uplink control channel, PUCCH, being pending;
a time that a PDCCH indicating a new transmission addressed to a Cell Radio Network Temporary Identifier, C-RNTI, of a Medium Access Control, MAC, entity not being received after successful reception of a Random Access Response for a Random Access Preamble not selected by the MAC entity among a contention-based Random Access Preamble; or
a time or time duration within a PTW.

In some embodiments, an LP-WUS active time may be based on an LP-WUS configuration.

In some embodiments, a DRX active time may be based on a DRX configuration.

### Aspect 2

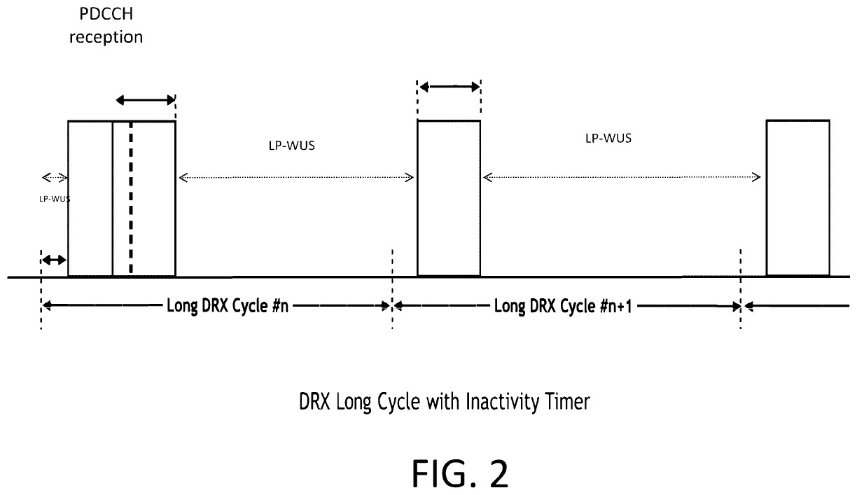

FIG. 2 illustrates a schematic diagram of monitoring method with DRX according to an embodiment of the present disclosure.

In some embodiments, the monitoring method comprise the LP-WUS monitoring and PDCCH monitoring or PO monitoring.

In some embodiments, as illustrated in FIG. 2, when DRX is configured, the LP-WUS is monitored outside the active time. The LP-WUS is also monitored during the time gap of DRX slot offset. The LP-WUS is monitored outside the active time with at least one of a periodicity, or duration.

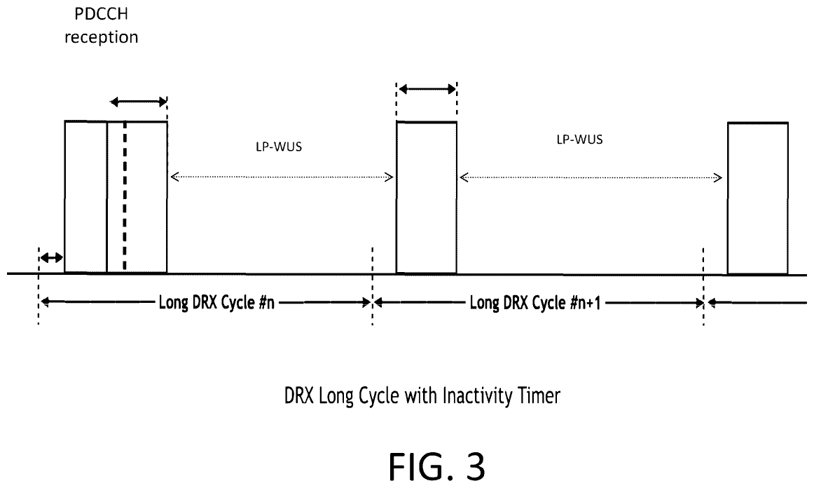

FIG. 3 illustrates a schematic diagram of monitoring method with DRX according to an embodiment of the present disclosure.

In some embodiments, as illustrated in FIG. 3, when DRX is configured, after the offset, the LP-WUS is monitored outside the DRX active time.

In some embodiments, the always-on monitoring may be configured via gNB configuration, e.g., when a parameter indicates 0, or a parameter is not configured, or the periodicity is equal to the duration.

In some embodiments, the always-on monitoring comprises continuous monitoring during a time or a window. In some embodiments, the always-on monitoring comprises continuous monitoring on the continuous occasions. In some embodiments, the always-on monitoring comprises continuous monitoring outside the active time. In some embodiments, the always-on monitoring comprises continuous monitoring outside the active time in connected mode, idle mode, or inactive mode.

In some embodiments, the LP-WUS indicates to activate or start a DRX, DRX configuration, or DRX timer; the LP-WUS indicates to activate or start a DRX, DRX configuration, or DRX timer for a long DRX cycle; the LP-WUS indicates to activate or start a DRX, DRX configuration, or DRX timer for a short DRX cycle; a first LP-WUS indicates to activate or start a long DRX and a second LP-WUS activates a short DRX; or the LP-WUS indicates to activate or start at least one of a long DRX or a short DRX based on at least one of a PDCCH or physical downlink shared channel, PDSCH.

In some embodiments, the LP-WUS comprises an indication for one or more window/duration activations or one or more timers. In this case, the LP-WUS is used to activate or trigger a time window/duration to monitor PDCCH, or start a timer, e.g., the LP-WUS timer to monitor PDCCH.

In some embodiments, the LP-WUS comprises an indication for one or more window/duration activations or one or more timers, when a high layer parameter is configured, a Medium Access Control Control Element, MAC CE, signaling or a Downlink Control Information, DCI, signaling is received.

In some embodiments, the LP-WUS comprises an indication for an offset. The offset indicates at least one of: a time gap between the LP-WUS and a DRX cycle, a start of a DRX timer, or a start of an LP-WUS timer; a time gap between the LP-WUS and a PTW; a time gap between the LP-WUS and a window; a first offset based on a long DRX and a second offset based on a short DRX; a first offset based on a start of a DRX timer or LP-WUS timer for a long DRX and a second offset based on a start of a DRX timer or LP-WUS timer for a short DRX; a first offset based on a PTW window, an Extended Discontinuous Reception, eDRX, cycle or a window and a second offset based on a DRX cycle, a start of a DRX timer, or a start of an LP-WUS timer.

In some embodiments, for example, 1 bit in an LP-WUS indicates activating the timer or DRX on_duration. In some embodiments, 1 bit in an LP-WUS indicates the UE to monitor PDCCH in the next DRX or in the active time in the next DRX.

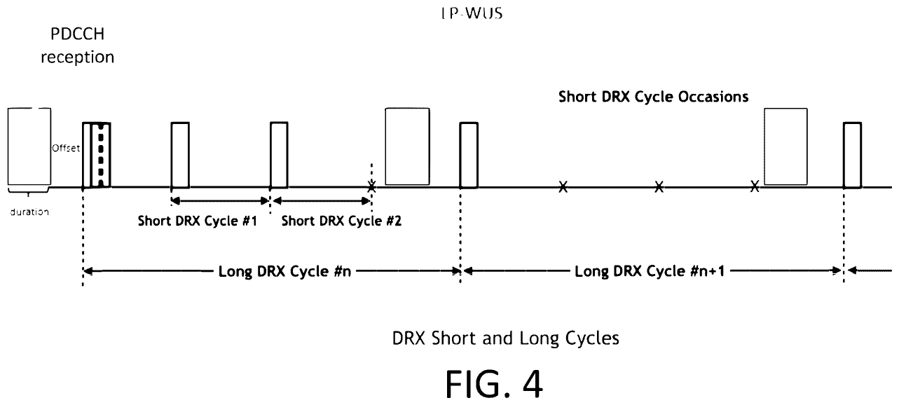

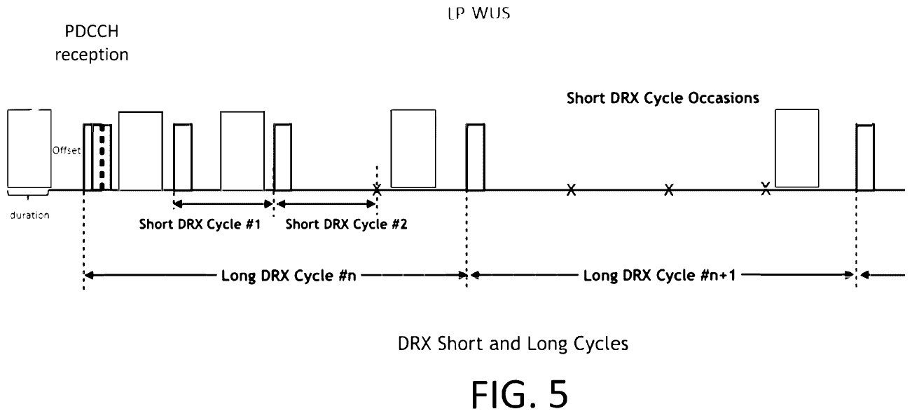

As shown in FIG. 4, the LP-WUS may be used to activate at least one next DRX. The number of bits in the LP-WUS depends on the LongCycle and/or ShortCycle. For example, when the number of bits is X,

$${2}^{X} = \frac{LongCycle}{ShortCycle} .$$

In some embodiments, for example, when the number of bits is ceil (log 2 (x)) bits in the LP-WUS,

$$X = \frac{LongCycle}{ShortCycle} ,$$

in which ceil is a cell function.

### Aspect 3

In some embodiments, the relationship between the LP-WUS and eDRX are described below. In some embodiments, with the configuration described below, the power consumption of the UE may be decreased.

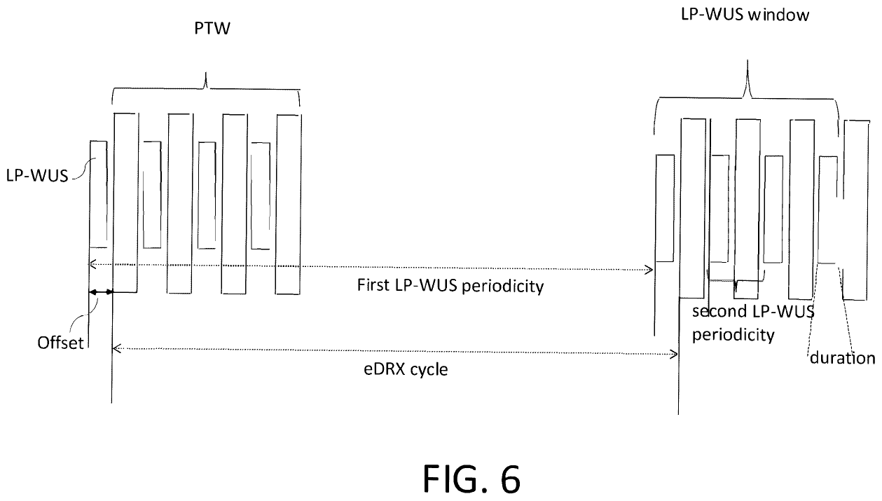

FIG. 6 illustrates a schematic diagram of monitoring method with DRX according to an embodiment of the present disclosure.

The LP-WUS may be configured as following:

The first periodicity is applied for the first LP-WUS and the second periodicity is applied for second LP-WUS. In some embodiments, the first periodicity is longer than the second periodicity.

In some embodiments, the second LP-WUS configuration is valid or can be activated when PTW contains at least one DRX cycle.

In some embodiments, the second LP-WUS monitoring is configured within the duration time or window of the first LP-WUS configuration.

In some embodiments, the first periodicity may be at least larger than the DRX cycle. The second periodicity may be no more than the length of PTW.

In some embodiments, the LP-WUS window may have the same length with PTW. In some embodiments, it may be configured to contain the PTW or DRXs in the PTW window.

In some embodiments, the first periodicity for the LP-WUS window could be the same with eDRX cycle.

In some embodiments, the LP-WUS is monitored based on at least one of a first periodicity and a second periodicity, the at least one of the first periodicity and the second periodicity satisfies at least one of: the second periodicity is applied for a Page Time Window, PTW, containing at least one DRX cycle; the first periodicity is applied for an Extended Discontinuous Reception, eDRX, cycle; the second periodicity is applied for a short DRX cycle; the first periodicity is applied for a long DRX cycle; the first periodicity is applied for a window; the second periodicity is applied within a window; the first periodicity is applied for a first LP-WUS and the second periodicity is applied for a second LP-WUS; the first periodicity is applied for a first monitoring search space of the LP-WUS and the second periodicity is applied for a second monitoring search space of the LP-WUS; or the first periodicity and second periodicity have a relationship of multiple times.

In some embodiments, the first periodicity P1 and second periodicity P2 have a relationship of multiple times. For example, P1=N*P2 or P2=N*P1, where N is larger than 0.

In some embodiments, the first periodicity is applied for a first monitoring search space of the LP-WUS and the second periodicity is applied for a second monitoring search space of the LP-WUS. For example, for different LP-WUS/LP-SS (low power synchronization signal) monitoring space, a periodicity can be configured, where monitoring space determines the location for monitoring the LP-WUS/LP-SS.

In some embodiments, the first periodicity is applied for a first LP-WUS and the second periodicity is applied for a second LP-WUS, wherein the first LP-WUS and second LP-WUS may carry different information, or the first LP-WUS and second LP-WUS may refer to a sync signal and a wake-up signal, or the first LP-WUS and second LP-WUS corresponds to different format or monitoring space.

In some embodiments, the LP-WUS is monitored in a window, and the window satisfies at least one of: a length of the window is equal to a length of a PTW; the window contains a PTW or contains at least a DRX cycle in a PTW; the window contains at least one time duration; the window is located before a start of a DRX timer or outside a DRX active time; a periodicity is associated with the window; a periodicity of the window is associated or equal to a periodicity of an Extended Discontinuous Reception, eDRX, cycle; or there is an offset between the window and a PTW, a DRX cycle, an eDRX cycle, a start of a DRX timer, a start of an LP-WUS timer, or a time point.

In some embodiments, the LP-WUS satisfies at least one of: the LP-WUS is monitored outside the active time; the LP-WUS is monitored outside a DRX active time; the LP-WUS is monitored before a start of a DRX timer or an LP-WUS timer; the LP-WUS is monitored in a PTW; or the LP-WUS is monitored outside the active time or before the active time but in a PTW. In some embodiments, the LP-WUS further satisfies at least one of: the LP-WUS is monitored in at least a time duration; or the LP-WUS is monitored with a periodicity.

In some embodiments, the offset between the LP-WUS window and PTW or DRX cycle or eDRX cycle or a time point may not be larger than the DRX cycle.

Within the window, or in the parameter for window, the LP-WUS could be optionally configured with at least one of the following attributes:

### 1. The Second Periodicity.

In some embodiments, the second periodicity is the same with DRX cycle. In some embodiments, the second periodicity is larger or smaller than DRX cycle. In some embodiments, the second periodicity is applied within the window or is configured to be associated with the window.

2. The Duration or Timer for durationON:

In some embodiments, the duration or timer for the on duration (e.g., durationON) may be used to allow the UE to monitor the LP-WUS(s) in the duration during the timer running. In some embodiments, the duration or timer is applied within the window or is configured to be associated with the window.

### 3. The Second Offset or the Duration and the Window:

In some embodiments, the second offset or the duration and the window have the same offset or starting position. In some embodiments, the second offset is applied within the window.

In some embodiments, the corresponding UE behavior is that the UE receives or monitors the LP-WUS(s) according to the above configuration (e.g., the configuration for monitoring the LP-WUS(s)) described above. For example:
the UE performs the always-on monitoring the LP-WUS(s) in a window,
the UE performs the always-on monitoring in PTW,
the UE performs the always-on monitoring in a window and outside the DRX active time
the UE performs the always-on monitoring outside the DRX active time within the PTW, starting from a time point based on an offset, in which the always-on monitoring is configured by the gNB, or may be determined by some configurations, e.g., when the second periodicity or duration or time or offset are not configured, or when no parameter in window is configured,
the UE performs the duty cycle monitoring, wherein the first periodicity is configured, and/or
the UE performs the duty cycle monitoring based on the window, and optionally the second periodicity is configured.

### Aspect 4

In some embodiments, the wireless communication method, wherein in response to an LP-WUS function being configured or enabled, or the LP-WUS is received. In some embodiments, when LP-WUS is configured (e.g., the LP-WUS function or parameter is configured) and the LP-WUS active time is defined, the most recent CSI measurement occasion occurs in the LP-WUS active time for CSI to be reported. For example:
if the UE is configured with DRX or LP-WUS (e.g., configured with the DRX or LP-WUS function), there are some possibilities to be considered;
if the UE is configured to monitor Downlink Control Information (DCI) format 2_6 and configured by higher layer parameter ps-TransmitOtherPeriodicCSI to report CSI, with the higher layer parameter reportConfigType set to ‘periodic’ and reportQuantity set to quantities other than ‘cri-RSRP’ and ‘ssb-Index-RSRP’, when drx-onDurationTimer in DRX configuration is not started, the most recent CSI measurement occasion occurs in DRX active time or during the time duration indicated by drx-onDurationTimer in DRX configuration also outside DRX active time for CSI to be reported;
if the UE is configured to monitor DCI format 2_6 and configured by higher layer parameter ps-TransmitPeriodicLI-RSRP to report L1-RSRP. with the higher layer parameter reportConfigType set to ‘periodic’ and reportQuantity set to cri-RSRP, when drx-onDurationTimer in DRX configuration is not started, the most recent CSI measurement occasion occurs in DRX active time or during the time duration indicated by drx-onDurationTimer in DRX configuration also outside DRX active time for CSI to be reported;
otherwise, the most recent CSI measurement occasion occurs in the DRX or LP-WUS active time for CSI to be reported.

In some embodiments, when LP-WUS is configured, the UE does not need to perform measurement of CSI-Reference Signal (RS) resources other than during the active time. For example,

if the UE is configured with DRX or LP-WUS, the UE is not required to perform measurement of CSI-RS resources other than during the active time for measurements based on CSI-RS-Resource-Mobility. In some embodiments, when the UE is configured to monitor DCI format 2_6, the UE is not required to perform measurements other than during the active time and during the timer duration indicated by drx-onDurationTimer in DRX configuration also outside active time based on CSI-RS-Resource-Mobility.

In some embodiments, when LP-WUS is configured, the UE may not expect CSI-RS resources are available other than during the active time for measurements based on CSI-RS-Resource-Mobility. For example, if the UE is configured with DRX and DRX cycle in use is larger than 80 msec, or configured with LP-WUS, the UE may not expect CSI-RS resources are available other than during the active time for measurements based on CSI-RS-Resource-Mobility. If the UE is configured with DRX and configured to monitor DCI format 2_6 and DRX cycle in use is larger than 80 msec, the UE may not expect that the CSI-RS resources are available other than during the active time and during the time duration indicated by drx-onDurationTimer in DRX configuration also outside active time for measurements based on CSI-RS-Resource-Mobility. Otherwise, the UE may assume CSI-RS are available for measurements based on CSI-RS-Resource-Mobility.

The UE reports a CSI report only if receiving at least one CSI-RS transmission occasion for channel measurement and CSI-RS and/or CSI-IM occasion for interference measurement in the LP-WUS active time no later than CSI reference resource. Otherwise, the UE drops the CSI report.

For example, when DRX is configured, the UE reports a CSI report if receiving at least one CSI-RS transmission occasion for channel measurement and CSI-RS and/or CSI-IM occasion for interference measurement in the DRX active time or LP-WUS active time no later than CSI reference resource. Otherwise, the UE drops the CSI report. When DRX is configured and the CSI-RS Resource Set for channel measurement corresponding to a CSI report is configured with two Resource Groups and N Resource Pairs, the UE reports a CSI report only if receiving at least one CSI-RS transmission occasion for each CSI-RS resource in a Resource Pair within the same DRX active time or LP-WUS active time no later than CSI reference resource and drops the report otherwise.

Some configuration limitation or UE behavior limitation could be as following:

The UE is not expected to receive the configuration of monitoring DCI format 2_6 and the LP-WUS at the same time.

The UE does not monitor the LP-WUS(s) during the active time.

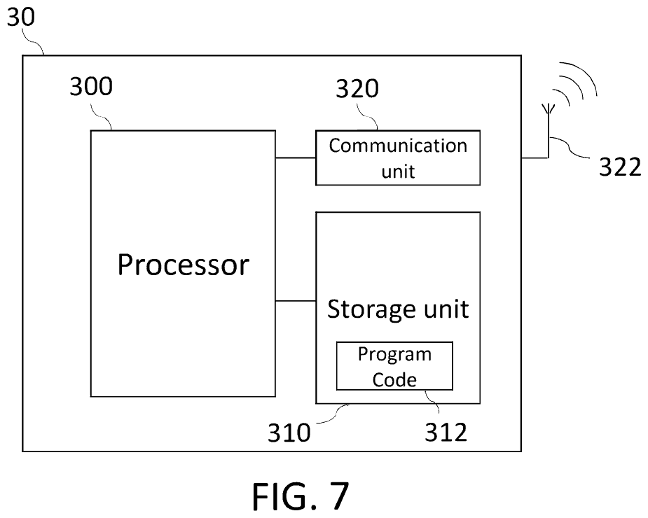

FIG. 7 relates to a diagram of a wireless communication terminal 30 according to an embodiment of the present disclosure. The wireless communication terminal 30 may be a tag, a mobile phone, a laptop, a tablet computer, an electronic book or a portable computer system and is not limited herein. The wireless communication terminal 30 may be used to implement the UE described in this disclosure. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322 or via wiring.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the UE described in this disclosure. In some embodiments, the processor 300 and the communication unit 320 collaboratively perform the operations described in this disclosure. For example, the processor 300 performs operations and transmit or receive signals, message, and/or information through the communication unit 320.

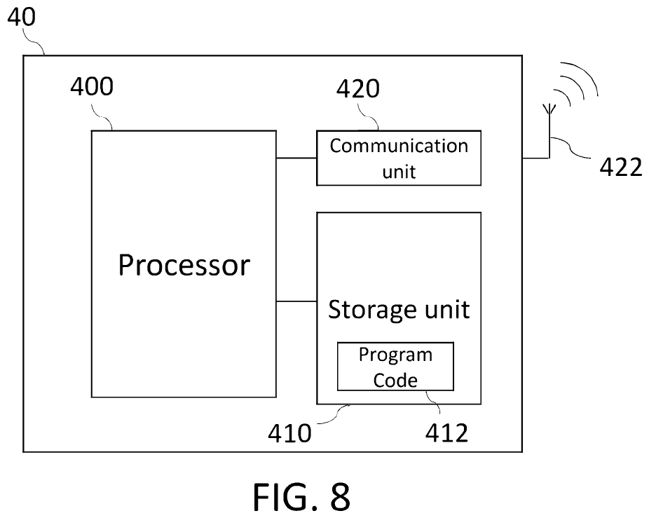

FIG. 8 relates to a diagram of a wireless communication node 40 according to an embodiment of the present disclosure. The wireless communication node 40 may be a satellite, a base station (BS), a gNB, a network entity, a Domain Name System (DNS) server, a Mobility Management Entity (MME), Serving Gateway (S-GW), Packet Data Network (PDN) Gateway (P-GW), a radio access network (RAN), a next generation RAN (NG-RAN), a data network, a core network, a communication node in the core network, or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may be used to implement the gNB described in this disclosure. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an embodiment, the communication unit 420 transmits and receives the signals via at least one antenna 422 or via wiring.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

In some embodiments, the wireless communication node 40 may be used to perform the operations of the gNB described in this disclosure. In some embodiments, the processor 400 and the communication unit 420 collaboratively perform the operations described in this disclosure. For example, the processor 400 performs operations and transmit or receive signals through the communication unit 420.

A wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 30 described in this disclosure, but is not limited thereto.

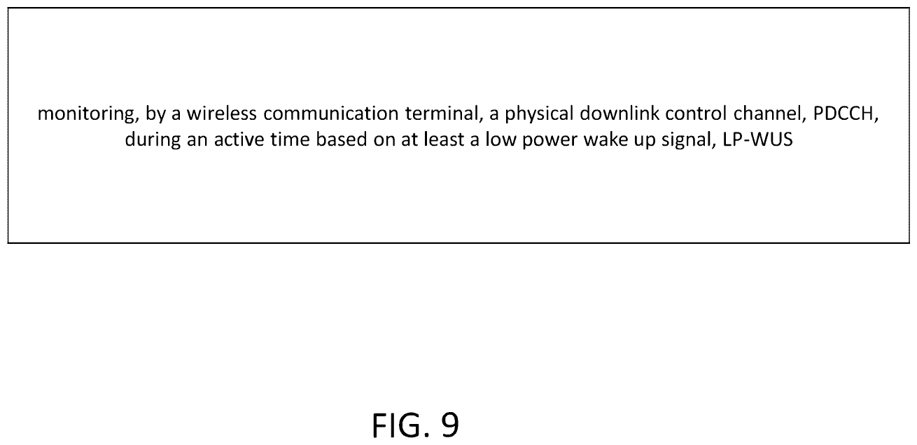

Referring to FIG. 9, in an embodiment, the wireless communication method includes: monitoring, by a wireless communication terminal, a physical downlink control channel, PDCCH, during an active time based on at least a low power wake up signal, LP-WUS.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a gNB). In an embodiment, the wireless communication node may be implemented by using the wireless communication node 40 described in this disclosure, but is not limited thereto.

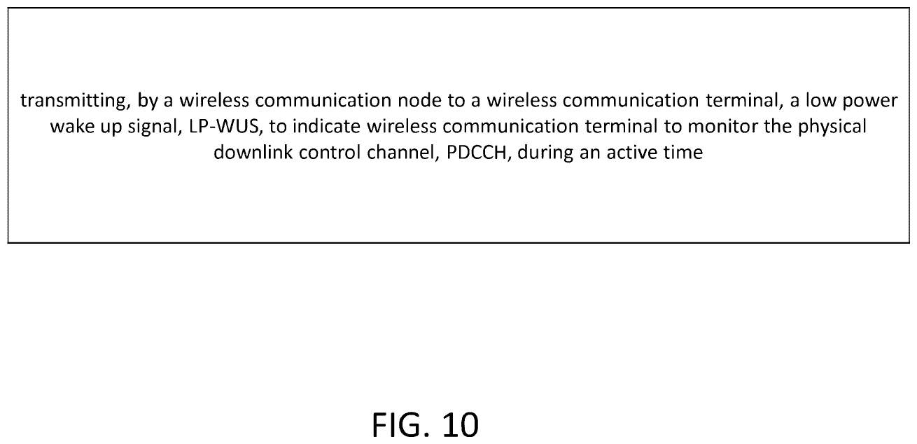

Referring to FIG. 10, in an embodiment, the wireless communication method includes transmitting, by a wireless communication node to a wireless communication terminal, a low power wake up signal, LP-WUS, to indicate wireless communication terminal to monitor the physical downlink control channel, PDCCH, during an active time.

Details in this regard can be ascertained with reference to the paragraphs above, and will not be repeated herein.

In some embodiments, the wireless communication terminal used in the present disclosure may indicate the UE described above.

In some embodiments, the wireless communication node used in the present disclosure may indicate the gNB described above.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is understood that, in the present disclosure, the term “and/or” or symbol “/” may include any and all combinations of one or more of the associated listed items. For example, A and/or B and/or C includes any and all combinations of one or more of A, B, and C, including A, B, C, A and B, A and C, B and C, and a combination of A and B and C. Likewise, A/B/C includes any and all combinations of one or more of A, B, and C, including A, B, C, A and B, A and C, B and C, and a combination of A and B and C.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general-purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method comprising:
monitoring, by a wireless communication terminal, a physical downlink control channel (PDCCH) during an active time based on at least a low power wake up signal (LP-WUS).

2. The wireless communication method of claim 1, wherein the active time is determined by an LP-WUS timer or a Discontinuous Reception (DRX) timer,
wherein an LP-WUS active time is determined by the LP-WUS timer
wherein a DRX active time is determined by the DRX timer.

3. The wireless communication method of claim 2, wherein the DRX timer comprises at least one of:
a DRX on-Duration Timer;
a DRX Inactivity Timer;
a DRX Retransmission Timer for downlink (DL);
a DRX Retransmission Timer for uplink (UL);
a DRX Hybrid Automatic Repeat Request (HARQ) round trip time (RTT) Timer for DL; or
a DRX HARQ RTT Timer for UL.

4. The wireless communication method of claim 2, wherein the LP-WUS timer comprises at least one of:
an LP-WUS on-Duration Timer,
an LP-WUS Inactivity Timer,
an LP-WUS Retransmission Timer for downlink (DL), or
an LP-WUS Retransmission Timer for uplink (UL);
an LP-WUS HARQ RTT Timer for DL; or
an LP-WUS HARQ RTT Timer for UL; and/or
wherein the LP-WUS timer or DRX timer is triggered by the LP-WUS, or by the LP-WUS in response to a high layer configuration.

5. The wireless communication method of claim 1, wherein the active time comprises at least one of:
a time of an LP-WUS on-Duration Timer being running;
a time of an LP-WUS Inactivity Timer being running;
a time of an LP-WUS Retransmission Timer for DL being running;
a time of an LP-WUS Retransmission Timer for UL being running;
a time of an LP-WUS HARQ RTT Timer for DL being running;
a time of an LP-WUS HARQ RTT Timer for UL being running;
a time of a DRX on-Duration Timer being running;
a time of a DRX Inactivity Timer being running;
a time of a DRX Retransmission Timer for DL being running;
a time of a DRX Retransmission Timer for UL being running;
a time of a ra-ContentionResolutionTimer being running;
a time of msgB-ResponseWindow;
a time of a Scheduling Request sent on a physical uplink control channel, PUCCH, being pending;
a time that a PDCCH indicating a new transmission addressed to a Cell Radio Network Temporary Identifier (C-RNTI) of a Medium Access Control (MAC) entity not being received after successful reception of a Random Access Response for a Random Access Preamble not selected by the MAC entity among a contention-based Random Access Preamble; or
a time or time duration within a PTW.

6. The wireless communication method of claim 1, wherein the LP-WUS is monitored based on at least one of:
a periodicity,
a time duration, or
an offset.

7. The wireless communication method of claim 1,
wherein the LP-WUS comprises an indication for one or more DRX activations or one or more DRX timers,
wherein the LP-WUS satisfies at least one of:
the LP-WUS indicates to activate or start a DRX, DRX configuration, or DRX timer;
the LP-WUS indicates to activate or start a DRX, DRX configuration, or DRX timer for a long DRX cycle;
the LP-WUS indicates to activate or start a DRX, DRX configuration, or DRX timer for a short DRX cycle;
a first LP-WUS indicates to activate or start a long DRX and a second LP-WUS activates a short DRX; or
the LP-WUS indicates to activate or start at least one of a long DRX or a short DRX based on at least one of a PDCCH or physical downlink shared channel (PDSCH).

8. The wireless communication method of claim 1, wherein a high layer parameter is configured, a Medium Access Control Control Element (MAC CE) signaling or a Downlink Control Information (DCI) signaling is received.

9. The wireless communication method of claim 1, wherein the LP-WUS comprises an indication for an offset.

10. The wireless communication method of claim 9, wherein the offset indicates at least one of:
a time gap between the LP-WUS and a DRX cycle, a start of a DRX timer, or a start of an LP-WUS timer;
a time gap between the LP-WUS and a PTW;
a time gap between the LP-WUS and a window;
a first offset based on a long DRX and a second offset based on a short DRX;
a first offset based on a start of a DRX timer or LP-WUS timer for a long DRX and a second offset based on a start of a DRX timer or LP-WUS timer for a short DRX; or
a first offset based on a PTW window, an Extended Discontinuous Reception, eDRX, cycle or a window and a second offset based on a DRX cycle, a start of a DRX timer, or a start of an LP-WUS timer.

11. The wireless communication method of claim 1, wherein an LP-WUS occasion for monitoring the LP-WUS is located before a DRX cycle, or is associated with a DRX cycle, and/or
wherein the LP-WUS is monitored based on at least one of a first periodicity and a second periodicity.

12. The wireless communication method of claim 1, wherein the LP-WUS is monitored in a window, and the window satisfies at least one of:
a length of the window is equal to a length of a PTW;
the window contains a PTW or contains at least a DRX cycle in a PTW;
the window contains at least one time duration;
the window is located before a start of a DRX timer or outside a DRX active time;
a periodicity is associated with the window;
a periodicity of the window is associated or equal to a periodicity of an Extended Discontinuous Reception (eDRX) cycle; or
there is an offset between the window and a PTW, a DRX cycle, an eDRX cycle, a start of a DRX timer, a start of an LP-WUS timer, or a time point.

13. The wireless communication method of claim 1, wherein the LP-WUS satisfies at least one of:
the LP-WUS is monitored outside the active time;
the LP-WUS is monitored outside a DRX active time;
the LP-WUS is monitored before a start of a DRX timer or an LP-WUS timer;
the LP-WUS is monitored in a PTW;
the LP-WUS is monitored outside the active time or before the active time but in a PTW,
the LP-WUS is monitored in at least a time duration; or
the LP-WUS is monitored with a periodicity.

14. The wireless communication method of claim 1, further comprising at least one of:
the wireless communication terminal reporting recent channel status information, CSI, based on a most recent CSI measurement occasion occurring in the active time;
the wireless communication terminal performing measurement of channel status information reference signal, CSI-RS, in the active time;
the wireless communication terminal being not required to perform measurement of channel status information reference signal, CSI-RS, outside active time;
the wireless communication terminal expecting that CSI-RS resources are available in the active time;
the wireless communication terminal not expecting that CSI-RS resources are available outside active time;
the wireless communication terminal reporting a CSI report in response to receiving at least one of a CSI-RS transmission occasion for channel measurement and CSI-RS or a channel status information interference measurement (CSI-IM) occasion for interference measurement in an active time no later than a CSI reference resource;
the wireless communication terminal dropping a CSI report if not receiving at least one of a CSI-RS transmission occasion for channel measurement and CSI-RS or a CSI-IM occasion for interference measurement in an LP-WUS active time no later than a CSI reference resource;
the wireless communication terminal reporting a CSI report in response to receiving at least one CSI-RS transmission occasion for each CSI-RS resource in a Resource Pair within the active time no later than CSI reference resource;
the wireless communication terminal dropping a CSI report in response to not receiving at least one CSI-RS transmission occasion for each CSI-RS resource in a Resource Pair within the active time no later than CSI reference resource;
the wireless communication terminal not expecting to receive a configuration of monitoring a DCI format 2_6 and the LP-WUS at the same time; or
the wireless communication terminal being not required to monitor the LP-WUS during the active time.

15. A wireless communication method comprising:
transmitting, by a wireless communication node to a wireless communication terminal, a low power wake up signal (LP-WUS) to indicate wireless communication terminal to monitor the physical downlink control channel (PDCCH) during an active time.

16. The wireless communication method of claim 15, wherein the active time is determined by an LP-WUS timer or a Discontinuous Reception (DRX) timer,
wherein an LP-WUS active time is determined by the LP-WUS timer
wherein a DRX active time is determined by the DRX timer.

17. The wireless communication method of claim 16, wherein the DRX timer comprises at least one of:
a DRX on-Duration Timer,
a DRX Inactivity Timer;
a DRX Retransmission Timer for downlink (DL);
a DRX Retransmission Timer for uplink (UL);
a DRX Hybrid Automatic Repeat Request (HARQ) round trip time (RTT) Timer for DL; or
a DRX HARQ RTT Timer for UL.

18. The wireless communication method of claim 17, wherein the LP-WUS timer comprises at least one of:
an LP-WUS on-Duration Timer,
an LP-WUS Inactivity Timer,
an LP-WUS Retransmission Timer for downlink (DL), or
an LP-WUS Retransmission Timer for uplink (UL);
an LP-WUS HARQ RTT Timer for DL; or
an LP-WUS HARQ RTT Timer for UL.

19. A wireless communication terminal, comprising:
a communication unit; and
a processor configured to: monitor, via the communication unit, a physical downlink control channel (PDCCH) during an active time based on at least a low power wake up signal (LP-WUS).

20. A wireless communication node, comprising:
a communication unit; and
a processor configured to execute the method according to claim 15.
